(19) United States
(12) Patent Application Publication
(10) Pub. No.: US 2004/0064705 A1
(43) Pub. Date: Apr. 1, 2004

(54) Automated system and method for gaining access to restricted or controlled areas

(76) Inventor: Gregory M. Rivet, Lansing, MI (US)

Correspondence Address: KNECHTEL DEMEUR & SAMLAN, ATTN: ALAN B. SAMLAN, 222 S. RIVERSIDE, SUITE 1410, CHICAGO, IL, 60606, US

(21) Appl. No.: 10/260,883

(22) Filed: Sep. 30, 2002

(51) Int. Cl. H04K 1/00

(52) U.S. Cl. 713/182

(57) ABSTRACT

An automated method and system for gaining access to restricted or controlled areas. The system allows individuals to sign-in and request access to the facility or building that is restricted or controlled. The system will proceed through a series of prompts that require inputted information from the individual. The information will be processed and, if acceptable, the individual will be permitted to gain access to the restricted or controlled area. The system also allows the administrator to manage and oversee the administration of the system and individuals and prepare detailed reports based upon certain criteria. In particular, the system maintains the confidentiality of the individuals seeking access to the restricted or controlled area from the other individuals who are seeking the same access.

### I. FIELD OF THE INVENTION

The present invention relates to an automated system and method for gaining access to restricted or controlled areas. More particularly, the present invention involves a system which monitors, manages, and facilitates the efficient administration of gaining access to restricted or controlled areas for appointments, meetings, or other agenda.

### II. DESCRIPTION OF THE PRIOR ART

When a person enters a physicians office, secure building, pharmacy receipt automation, hotel, government agency, human resources department, security check point, etc . . . , that person is required to enter information to gain entry or access to that entity. This information is typically entered on a pre-printed access document with rows and columns for the person to enter their name, identification number, social security number, or any other information, personal or otherwise, that the entity would like to record on the access document. This same pre-printed document is repeatedly used as the access document for each subsequent person until the document is full, after which, the entity provides another pre-printed document to be completed by the next set of entrants. The problem with this access process is that the entrant's information is not maintained in a secure, confidential manner by the entity. In fact, each person that enters has full access to all the previous entrants' information on the document and may, if desired and due to its availability, use this information for improper purposes or illegal means.

There exists a number of patents relative to gaining access or entry through the use of computers but none solves the problem presented or solved by Applicant's invention. For example, U.S. Pat. No. 6,112,986 to Berger entitled “Method And Apparatus For Accessing Patient Insurance Information” (“Berger Patent”) discloses a method and apparatus for data management related to managed service and health care systems and, in particular, a means by which patient information is entered, accessed, and processed. The patient information is provided on a device physically similar to insurance cards or credit cards which is referred to as a “Medicompucard.” A receptionist scans the Medicompucard by means of a scanner keyboard wedge interface and saves the information into a text file such as notepad, wordpad, or write software program. The resulting text file is then imported into the physician's patient information database for further use. If the patient does not have a Medicompucard, the patient must instead fill out the patient information forms, after which, the receptionist manually enters the information into the physician's patient information database.

While the Medicompucard eliminates the manual sign in procedure of the physician's office, it does so in a different manner and by a different means than Applicant's invention. First, the Berger Patent requires a Medicompucard or other device physically similar to an insurance card or credit card. It does not relate to an actual sign in process where the patient electronically inputs information in response to prompted requests. Second, the Berger Patent requires a scanner keyboard wedge interface to read and scan the information from the Medicompucard or other type card device. Applicant's invention does not use a scanner or other one-directional device for insurance purposes. Rather, Applicant's invention uses hardware and software that bi-directionally communicates between the patient and the computer to gain access or entry to the restricted or controlled area. Third, the information from the Medicompucard is used to obtain the insurance information for the patient and facilitate processing of the visit for insurance purposes. It is not used in relation to the particulars of the appointment and/or waiting room information, management, or monitoring. As a result, the Berger Patent neither discloses nor teaches the aspects of Applicant's invention.

U.S. Pat. No. 6,307,955 to Zank entitled “Electronic Signature Management System” (“Zank Patent”) and U.S. Pat. No. 5,867,821 to Ballantyne entitled “Method And Apparatus For Electronically Accessing And Distributing Personal Health Care Information And Services In Hospitals and Homes” (“Ballantyne Patent”) also relate to gaining access through the use of electronic means. The Zank Patent discloses receiving an electronic handwritten signature and processing that signature for comparison with a reference signature. The Ballantyne Patent discloses the use of an electronic signature to gain access to the internal medical information network for the use of or modification of a patient's medical records. While the electronic signature is disclosed in the art, neither of these patents discloses or teaches the ability and method to bi-directionally transfer information between the patient and the client for signing the patient into a medical or other facility for appointment or for an authorized visitor to gain access to a controlled area.

U.S. Pat. 6,367,013 to Bisbee entitled “System And Method For Electronic Transmission, Storage, And Retrieval of Authenticated Electronic Original Documents” (“Bisbee Patent”); U.S. Pat. No. 6,076,166 to Moshfeghi entitled “Personalizing Hospital Intranet Web Sites” (“Moshfeghi Patent”); U.S. Pat. No. 6,032,137 to Ballard entitled “Remote Image Capture With Centralized Processing And Storage” (“Ballard Patent”); and U.S. Pat. No. 5,604,802 to Holloway entitled “Transaction Processing System” (“Holloway Patent”) all disclose the electronic transfer and use of information over computers. However, none of these patents teach or disclose the particular method and process between the entrant (e.g., patient) and an entity that forms the basis of Applicant's invention.

Thus, there has never been disclosed a system which monitors, manages, and facilitates the efficient administration of access to restricted or controlled areas while providing the entrant's information in a confidential and secure manner.

### III. OBJECTS OF THE INVENTION

It is the primary object of the present invention to provide a system and method to permit individuals to gain access to restricted or controlled areas. A related object of the present invention is to provide a system that is computer automated.

Another object of the present invention is to obtain confidential and other information from the entrant gaining access to the entity or facility. A related object of the invention is to provide a system for the receipt and processing of that information in a confidential manner

Another object of the present invention is to provide a system that maintains the entrant's information in a secure environment. A related object of the invention is to provide a system where entrants seeking to gain access to the same entity or facility are prevented from access to confidential and secure information of previous entrants to the entity or facility.

Still another related object of the present invention is to provide a quality system that is inexpensive to manufacture. A related object of the invention is to provide a system that is safe and easy to use.

Other objects of the present invention will become more apparent to persons having ordinary skill in the art to which the present invention pertains from the following description taken in conjunction with the accompanying drawings.

### IV. SUMMARY OF THE INVENTION

The present invention is an automated method and system for gaining access to restricted or controlled areas. The system allows individuals to sign-in and request access to the facility or building that is restricted or controlled. The system will proceed through a series of prompts that require inputted information from the individual. The information will be processed and, if acceptable, the individual will be permitted to gain access to the restricted or controlled area. The system also allows the administrator to manage and oversee the administration of the system and the individuals as well as prepare detailed reports based upon certain criteria relating to this administration and the individuals.

### V. BRIEF DESCRIPTION OF THE DRAWINGS

The Description of the Preferred Embodiment will be better understood with reference to the following figures:

FIG. 1 is a diagram illustrating the computer hardware used in Applicant's system for gaining access to restricted or controlled areas.

FIG. 2 is a flowchart illustrating the basic operation of Applicant's computer software system for gaining access to restricted or controlled areas.

FIG. 3 is a top planar view, with portions removed, of the tableture depicting the Introduction Screen.

FIG. 4 is a top planar view, with portions removed, of the tableture depicting the Client Identification Screen.

FIG. 5 is a top planar view, with portions removed, of the tableture depicting the Client Verification Screen.

FIG. 6 is a top planar view, with portions removed, of the tableture depicting the Client Re-Enter Screen.

FIG. 7a is a top planar view, with portions removed, of the tableture depicting the Reason For Visit Screen.

FIG. 7b is a top planar view, with portions removed, of the tableture depicting the Doctor List Screen.

FIG. 8 is a top planar view, with portions removed, of the tableture depicting the Greeting Screen.

FIG. 9 is a front planar view of the Main Screen depicting the individuals seeking to gain access to the restricted or controlled area.

FIG. 10 is a front planar view of the Database Screen depicting the information relating to the individual seeking to gain access to the restricted or controlled area on a particular day.

FIG. 11 is a front planar view of the Database Screen depicting the information relating to all the individuals stored in the system who have sought to gain access to the restricted or controlled area at some point in time.

FIG. 12a is a front planar view of the LCD Screen depicting the screen to edit the reasons for requesting access to the restricted or controlled area.

FIG. 12b is a front planar view of the LCD Screen depicting an alternate embodiment of the screen to edit the names of the doctors for the individual to gain access to the restricted or controlled area to see.

FIG. 13 is a front planar view of a report of the average waiting room time for an individual to gain access to the restricted or controlled area.

FIG. 14 is a front planar view of a report of the average clinical time for an individual to remain in the restricted or controlled area after gaining access.

FIG. 15 is a front planar view of a report of the total number of individuals that gained access to the restricted or controlled area during a certain period of time.

FIG. 16 is a front planar view of a report of the number of reasons used by the individuals for gaining access to the restricted or controlled area over a certain period of time.

FIG. 17 is a front planar view of a LCD Pad Options screen providing the user with several selections relating to enabling and disabling the steps of the process and software system.

FIG. 18 is a front planar view of a Sign-In Sheet Options screen providing the user with several administrative selections relating to the process and software system.

### VI. DETAILED DESCRIPTION OF THE PREFERRED EMBODIMENT

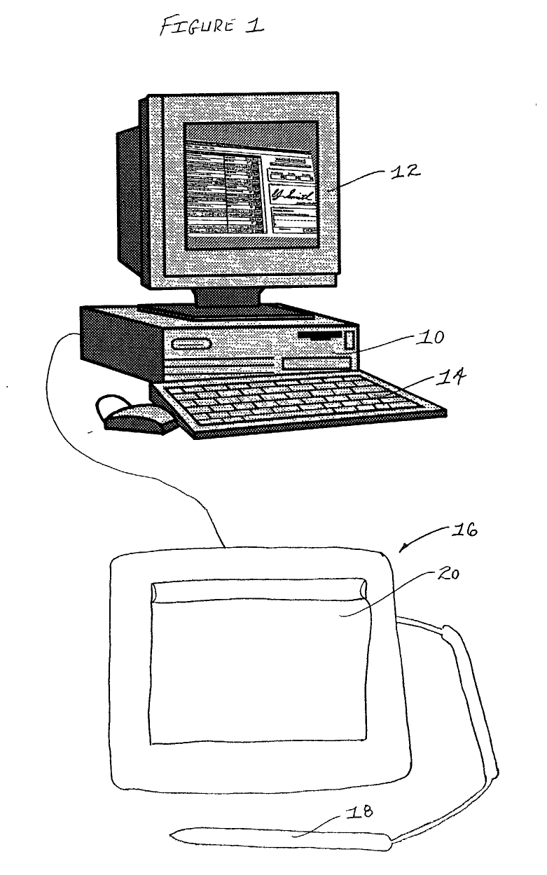

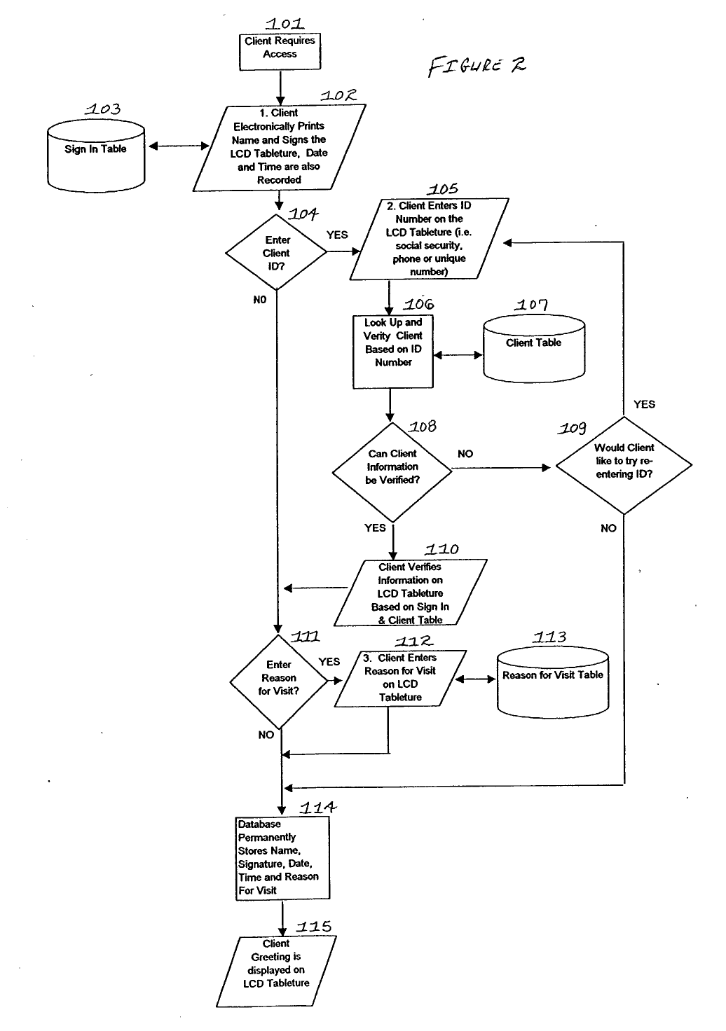

Applicant's invention consists of the interaction between the computer hardware, as illustrated in FIG. 1, and the computer software system, as illustrated in FIG. 2.

Turning to FIG. 1, the computer hardware consists of a central processing unit 10, a computer screen 12, a keyboard 14, and a tableture 16 (i.e., electronic tablet). The central processing unit 10, the computer screen 12, the keyboard 14, and the tableture 16 are well known in the art and it is contemplated that any compatible type, version, or size made by any manufacturer is acceptable to accomplish the intended purposes of Applicant's invention. The central processing unit 10 houses the circuitry comprising the cpu itself, RAM and ROM memory components, video interface circuitry, and other hardware that allows connection to the other components described herein. Preferably, to install and run the computer software, the central processing unit 10 should provide at least a Pentium III microprocessor, 128 megabytes of read access memory, 40 megabytes of available hard disk space, and, for dos operating systems, use Microsoft Windows 98 or newer version. Alternatively, the computer software can be modified for use with both Macintosh and Unix based systems. In the preferred embodiment with respect to the tableture 16, the tableture 16 is a Signature Gem 4×3 LCD tablet manufactured by Topaz Systems. The tableture 16 consists of an interactive tool 18 and a graphic LCD display 20. Preferably, the display 20 is 240×128 or 11 mm×6 mm and made of a rugged tempered glass surface. In the preferred embodiment, the tableture 16 provides a display 20 that uses touch sensitive technology to receive and process input information from the user.

Turning to FIG. 2, there is illustrated a schematic diagram of the basic operation of an automated system and method for entrants to gain access to restricted or controlled areas.

In Step 101, the entrant, client, or patient (hereinafter referred to as “individual”) requires access to the restricted or controlled area. In the preferred embodiment, the restricted or controlled area includes but is not limited to a medical facility, dental facility, health care facility, pharmacy, child care facility, security buildings, financial services facilities, legal offices, accounting firms, or any other facility or building that implements a security system that restricts access to that facility or building.

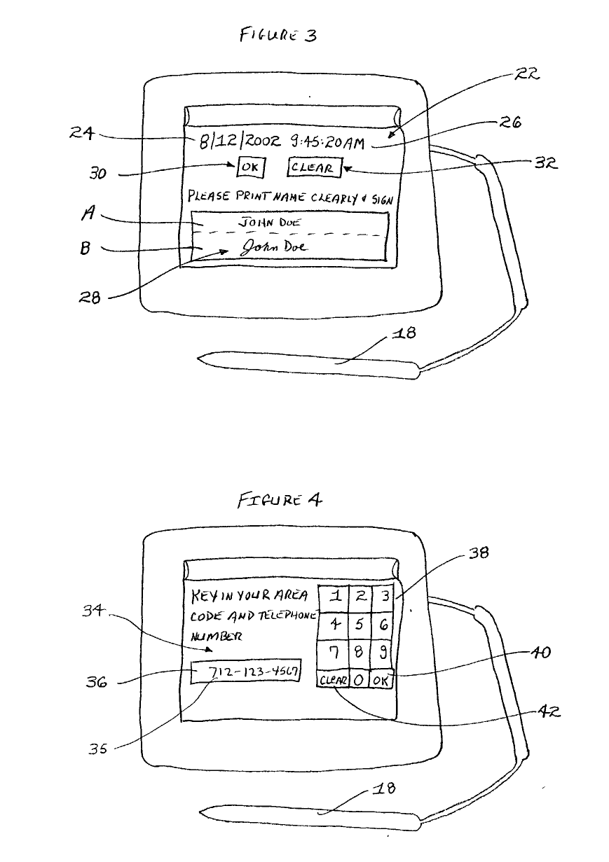

In Step 102, the individual begins the access process by approaching the tableture 16. Upon approaching the tableture 16, the tableture 16 automatically displays an Introduction Screen 22 as illustrated in FIG. 3. The Introduction Screen 22 displays a date 24, a time 26, and a signature line 28. The individual uses the interactive tool 18 to print his/her name along line A and enter his/her signature along line B of the display 20 of the Introduction Screen 22. Upon completion, if the signature is accurate, the individual enters the signature by pressing an OK Button 30 with the interactive tool 18. If the individual is not satisfied with the signature or accidentally signed his/her name different than usual, the individual can clear the executed signature by pressing a Clear Button 32 with the interactive tool 18. Once cleared, the individual re-prints the name along line A and re-executes the signature along line B and then enters the signature with the OK Button 30. Once entered, the executed signature is received and stored in the sign-in database in Step 103.

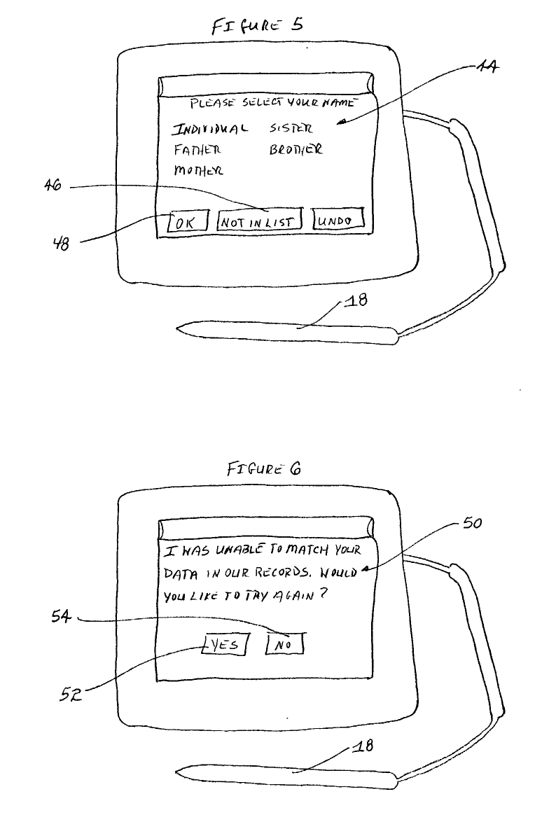

In Step 104, a Personal Identification Screen 34, as illustrated in FIG. 4, requests the individual to enter a client identification number 35. In the non-limiting example as illustrated in FIG. 4, the request is to “Key in your area code and telephone number:” to be used as the client identification number 35. Alternatively, it is contemplated that any type or kind of information may be used as a client identification number including but not limited to any combination of assigned number(s) (i.e., unique number, social security number, telephone number), letter(s), and/or symbol(s). If the individual has a client identification number 35, the individual proceeds to Step 105. Alternatively, if the individual does not have a client identification number 35, the individual presses an OK Button 40 with the interactive tool 18 to enter a blank client identification number 35 and proceed directly to Step 111.

In Step 105, as further illustrated in FIG. 4, a client identifier box 36 is provided for the individual to enter the client identification number 35 (e.g., area code and telephone number in the current example) using a keypad 38 located adjacent to the client identifier box 36. The keypad 38 consists of numbers 0 through 9. Alternatively, depending upon the desired client identification number 35 to be entered, it is contemplated that any letter(s) or symbol(s) may be provided by the keypad 38. Upon entering the area code and telephone number or other client identification number 35, if the correct client identification number 35 is entered, the individual enters the client identification number 35 by pressing the OK Button 40 with the interactive tool 18. If the individual accidentally entered an incorrect client identification number 35, the individual can clear the client identifier box 36 by pressing a Clear Button 42 with the interactive tool 18. Once cleared, the individual re-enters the client identification number 35 in the client identifier box 36 and then presses the OK Button 40 with the interactive tool 18 to enter the client identification number 35 into the system and proceed to Step 106.

In Step 106, the entered client identification number 35 is received and verified with the client table in Step 107. The client table in Step 107 stores all the client identification numbers 35 that are assigned to the individual(s). The client table in Step 107 also provides and retains the information on the individual(s) including but not limited to name, address, telephone number, social security number, name of person the individual is visiting, or any other desired information. When an individual enters the client identification number 35 in Step 105, the entered client identification number 35 is compared with the client table in Step 107 to obtain the individual(s) that correspond to that client identification number 35. If any individual(s) correspond to the entered client identification number 3 5, the program proceeds to Step 108. By way of example, assume an individual lives at home with his father, mother, sister, and brother, and further that each share the same doctor who uses Applicant's invention. If that individual enters the doctor's office for an appointment and enters their area code and telephone number as the client identification number 35, then it is contemplated that the client identification number (e.g., area code and telephone number) may be the same for his father, mother, sister, and brother if they each maintain the same area code and telephone number with the doctor. In this instance, the individual, father, mother, sister, and brother would all be displayed in Step 108 for verification by the individual as to which person is desiring to gain access to the doctor's office.

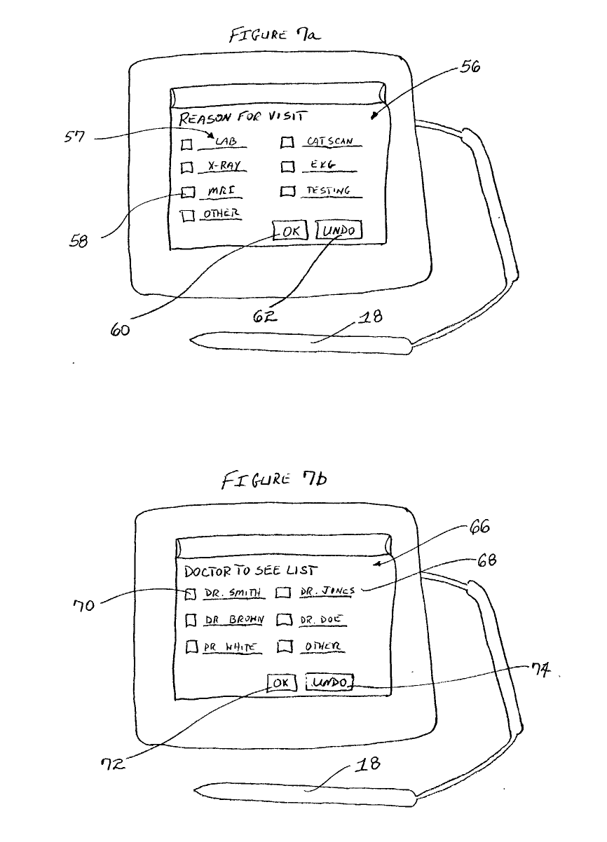

In Step 108, as illustrated in FIG. 5, a Client Verification Screen 44 appears. The Client Verification Screen 44 provides the names of the individual(s) that corresponded to the client identification number 35 entered in Step 105 and obtained in Steps 106 and 107. In the previous example, the Client Verification Screen 44 would list a total of five names: the individual, the father, the mother, the sister, and the brother, as each have the same client identification number. Upon review of the list of names, if the individual's name is listed, which it would be in the example, the individual verifies this information in Step 110 which is discussed below in further detail. If the individual's name is not listed, the individual proceeds to Step 109. As illustrated in the Client Verification Screen 44, a Not In List Box 46 is provided. Using the interactive tool 18, the individual presses it within the Not In List Box 46 and proceeds to Step 109 and a Client Re-Enter Screen 50 as illustrated in FIG. 6.

In Step 109, since the individual's name was not listed, the individual can re-try to enter their client identification number 35. One reason that the individual's name may not be listed is that the individual mistakenly entered an incorrect client identification number 35. The Client Re-Enter Screen 50 provides the text message “I was unable to match your data in our records. Would you like to try again? Alternatively, it is contemplated that any text message may be used provided that the individual understands how to choose between a Yes Box 52 and a No Box 54 which is provided. Using the interactive tool 18, the individual makes their decision. If the individual presses the Yes Box 52 with the interactive tool 18, the individual proceeds back to Step 105 to re-enter their client identification number 35 and then proceed back through the verification process in Steps 106 through 108. If the individual does not wish to re-enter their client identification number 35 or are not in the client table of Step 107, the individual can depress the No Box 54 with the interactive tool 18, in which instance, the individual will be prompted to “Please see the receptionist.” The receptionist, secretary or managing agent will then enter the individual's information into the system and proceed to Step 114.

In Step 110, if the individual's name was listed in the Client Verification Screen 44 of FIG. 5, the individual selects their name by depressing the interactive tool 18 on their name. This effectively highlights and selects their name, thereby, verifying the selected name as the person who is seeking access to the restricted or controlled area. After the individual selects their name, the individual presses an OK Button 48 with the interactive tool 18 and proceeds to Step 111.

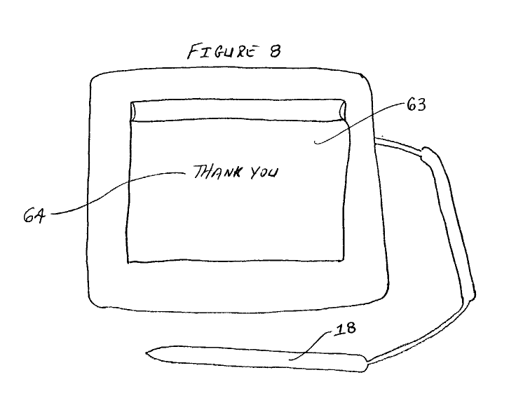

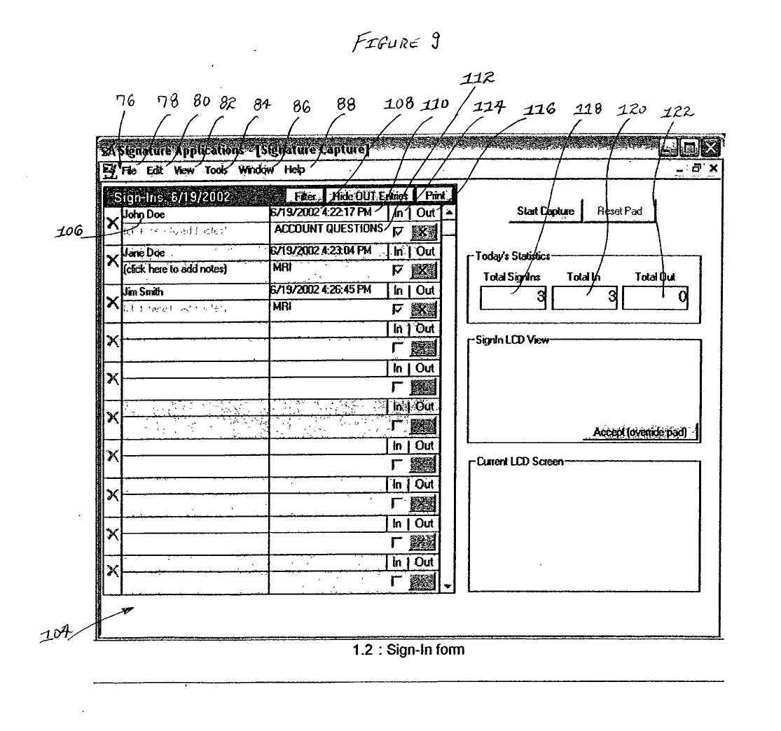

In Step 111, as illustrated in FIG. 7a, a Reason For Visit Screen 56 is provided that requires the individual to enter their reason for seeking access to the restricted or controlled area. Preferably, the Reason For Visit Screen 56 provides a list of reasons 57. The list of reasons 57 is stored in the reason for visit table in Step 113. Continuing with the doctor's office example, the list of reasons 57 includes but is not limited to lab, x-ray, mri, cat scan, ekg, pre-admit testing, admission, payment, account, and/or other. In another non-limiting example for a dental office, the list of reasons 57 may include but are not limited to crown, cleaning, follow-up, filling, cosmetic, plastic tray, metal tray, impression, and/or other. Alternatively, any reason may be required by the user and is dependent upon the restricted or controlled area for which the individual is seeking access. Located next to each reason 57 is an empty box 58. Using the interactive tool 18, the individual, in Step 112, makes their selection by pressing the appropriate empty box 58 with the interactive tool 18. Upon completion, the individual presses an Ok Button 60 with the interactive tool 18 on the Reason For Visit Screen 56 and proceeds to Step 114. If after making the reason for visit selection or the individual accidentally selects an incorrect reason 57, the individual may clear their selection by pressing an Undo Button 62, located within the Reason For Visit Screen 56, with the interactive tool 18. Once cleared, the individual re-enters their selection of the reason 57 for the visit. After the proper or desired selection is made in the appropriate empty box 58, the individual then presses the Ok Button 60 with the interactive tool 18 on the Reason For Visit Screen 56 and then proceeds to Step 114.

In an alternate embodiment, the Reason For Visit Screen 56 is replaced, as illustrated in FIG. 7b, with a Doctor To See List Screen 66 which provides a doctor list 68. The doctor list 68 is stored in a database table in Step 113. Continuing with the doctor's office example, the doctor list 68 includes specific names of the doctor and provides an “other” selection in case the individual's doctor is not listed in the doctor list 68. Located next to each doctor name is an empty box 70. Using the interactive tool 18, the individual, in Step 112, makes their selection by depressing the interactive tool 18 within the appropriate empty box 70. Upon completion, the individual presses the interactive tool 18 within an Ok Button 72 on the Doctor To See List Screen 66 and proceeds to Step 114. If the individual accidentally selects an incorrect doctor name, the individual may clear their selection by depressing the interactive tool 18 within an Undo Button 72 located within the Doctor To See List Screen 66. Once cleared, the individual re-enters the name of the doctor that they have an appointment with or are visiting. After the proper or desired selection is made, the individual then presses the Ok Button 72 with the interactive tool 18 on the Doctor To See List Screen 66 and then proceeds to Step 114. Alternatively, if desired, the user may customize any other type of screen or prompt in Step 111 for the individual.

In Step 114, the individual's name, signature from line B in FIG. 3, date 24, time 26, and reason for visit 57 is permanently stored in a database in the system. The reason that this information is stored is twofold: (1) to provide the secretary, receptionist, or managing agent with the current status of the individual seeking to gain access to the restricted or controlled area, and (2) to maintain an archive or history of the requests or access made by that individual to that particular facility or building. If the individual's name could not be verified in Steps 108 and 109, the secretary, receptionist, or managing agent can enter the individual's information into the system in this step. The process for entering the individual's information into the system is discussed in further detail below.

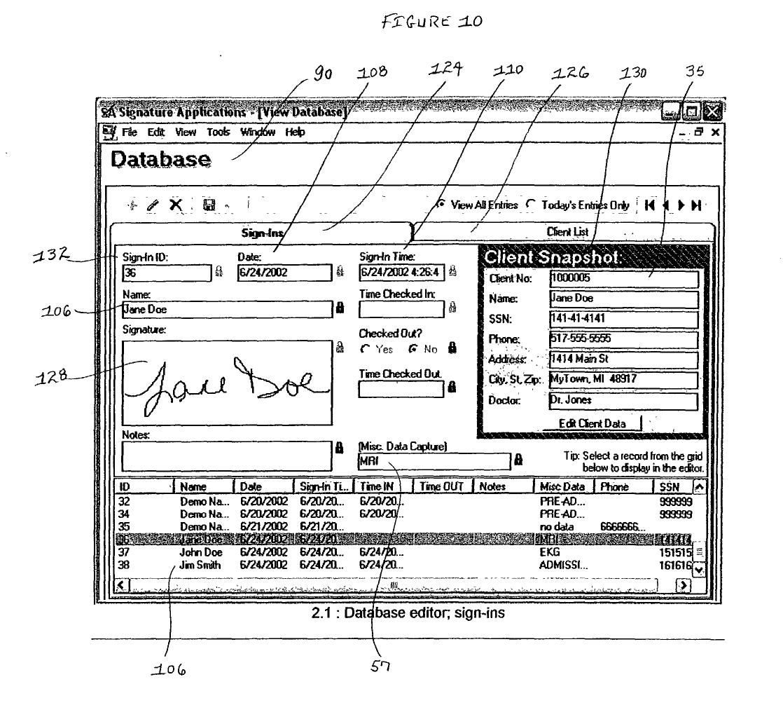

In Step 115, as illustrated in FIG. 8, a Greeting Screen 63 is displayed to the individual. In a non-limiting example, the Greeting Screen 63 provides a greeting 64. Preferably, the greeting 64 greets the individual with “Thank You”. Alternatively, the greeting 64 may be any kind or type of greeting desired by the user. It is also contemplated that a greeting 64 may provide instructions to the individual such as “Please see receptionist or secretary for further instructions”, “Please have a seat in a certain room, please proceed down the hall to a certain room”, “Please proceed to a particular elevator bank”, etc. . .

Although the process described above included Steps 101 through 115, it is contemplated that any variation or combination of these steps may be enabled or disabled, as desired by the user. For example, rather than proceed through all the Steps 101 through 1 15, the system may be programmed to proceed through the sequence of: Steps 101 through 103 (i.e., signature sequence), Steps 104 through 109 (i.e., client identification number and verification), and then Steps 114 through 115 (i.e., storing entry and displaying greeting); or Steps 101 through 103 (i.e., signature sequence), Steps 111 through 113 (i.e., reason for visit), and then Steps 114 through 115 (i.e., storing entry and displaying greeting).

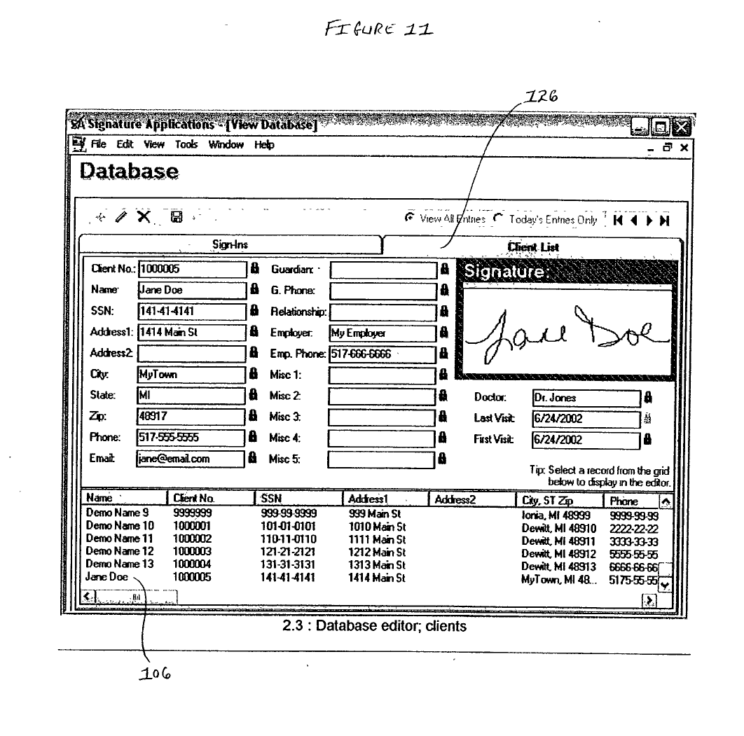

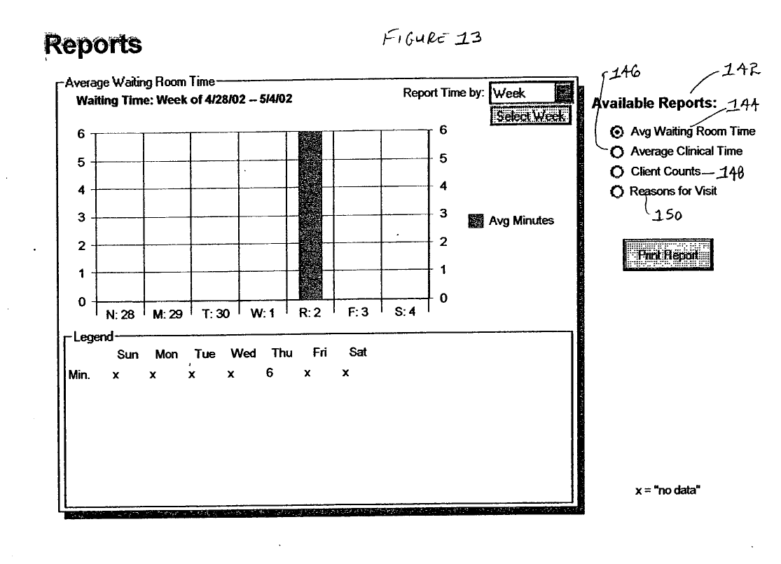

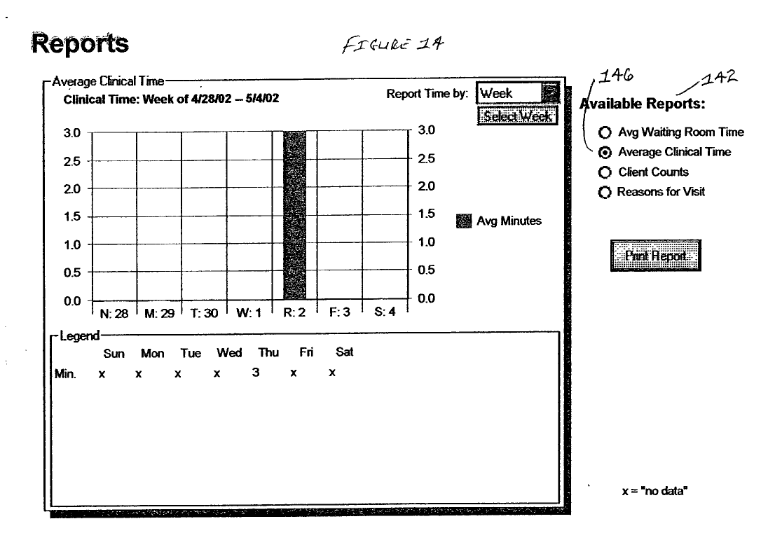

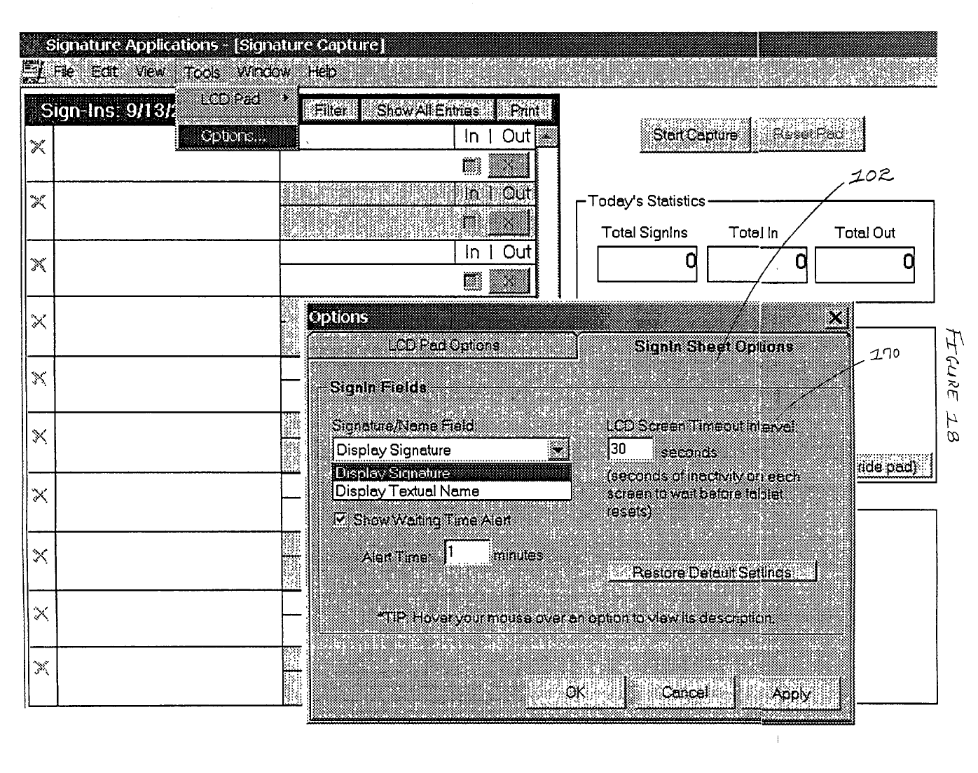

Upon completing the above process, the secretary, receptionist, or managing agent (hereinafter referred to as the “administrator”) administers, manages, and monitors the computer system using the program menu 76 as illustrated in FIG. 9. The program menu 76 consists of a file heading 78, an edit heading 80, a view heading 82, a tools heading 84, a window heading 86, and a help heading 88. Associated with each heading are options. With respect to the edit heading 80, a database option 90 (FIG. 10) and an LCD Screen 92 (FIG. 12a) option are provided. With respect to the view heading 82, a sign-in form option 94 (FIG. 9), a database option 96 (FIG. 10), and a reports option 98 are provided. With respect to the tools heading 84, an LCD pad option 100 (FIG. 17) and a sign-in sheet option 102 (FIG. 18) are provided.

Depicted along with the program menu 76 in FIG. 9 is the main screen 104. The main screen 104 is also the same screen that is provided in the sign-in form option 94. The main screen 104 provides a list of the names of the individuals 106 requesting to gain access to the restricted or controlled area. Associated with each individual 106 is the date 108, time 110, and reason for visit 112. Alternatively, the reason for visit 112 may be replaced with a doctor name 68 provided in FIG. 7b or any other information desired by the user. The date 108 and the time 110 is the same information that is provided in the date 24 and the time 26 in FIG. 3. The reason for visit 112 is the same information that is provided in the reason 57 in FIG. 7a. This information on the individual 106 is readily available to the user and, preferably, provides the names of the individuals 106 in order of date 108 and time 110. For example, the earliest individual 106 to request access to the restricted or controlled area will be displayed at the top of the list. The individual who arrived later in date 108 and time 1 10 will be displayed in order of time on the main screen 104 list. In this manner, the individual 106 who has waited the longest will receive priority over those individuals 106 that arrived after that person.

The main screen 104 provides an In Box 114 and an Out Box 116 to monitor the status of the individuals 106. When the individual 106 is approved for access into the restricted or controlled area, the administrator checks the In Box 114 to indicate that the individual 106 has now entered the restricted or controlled area. Once the individual 106 enters, their name on the main screen 104 list is displaced to the bottom of the list, thereby, allowing the next individual 106 with the longest wait time to be displayed at the top of the main screen 104 list. When the individual 106 completes their visit of the restricted or controlled area and exits the facility or building, the administrator checks the Out Box 1 16 to indicate that the individual 106 has now left the restricted or controlled area. Once the individual 106 vacates the facility or building, that individual's name is removed from the main screen 104 list altogether. The statistics of the daily sign-ins, those granted access, and those exiting the facility or building after being granted access is qualitatively displayed in the Total Sign-Ins Box 118, Total In Box 120, and Total Out Box 122.

Under the edit heading 80, the database option 90 is illustrated in FIG. 10. The database option 90 consists of a Sign-Ins Folder 124 and a Client List Folder 126. The Sign-Ins Folder 124 displays the individuals 106 that have signed in requesting access to the restricted or controlled area that day and provides the administrator with a quick overview of the primary information on each individual 106. By highlighting a specific individual 106, that person's information is displayed for viewing by the administrator. The information displayed consists of a sign-in number 132, the date 108, the time 110, the name of the individual 106, the reason for visit 57, a signature 128 from the signature line 28. Also displayed is a Client Snapshot 130 which provides the client identification number 35 and other information such as social security number, phone number, address, city, state, zip code, and doctor name. Alternatively, any other information of the individual 106 may be provided in the Client Snapshot 130 that is desired by the user. Any information in the database option 90 of an individual 106 may be changed at this screen by the administrator, if desired.

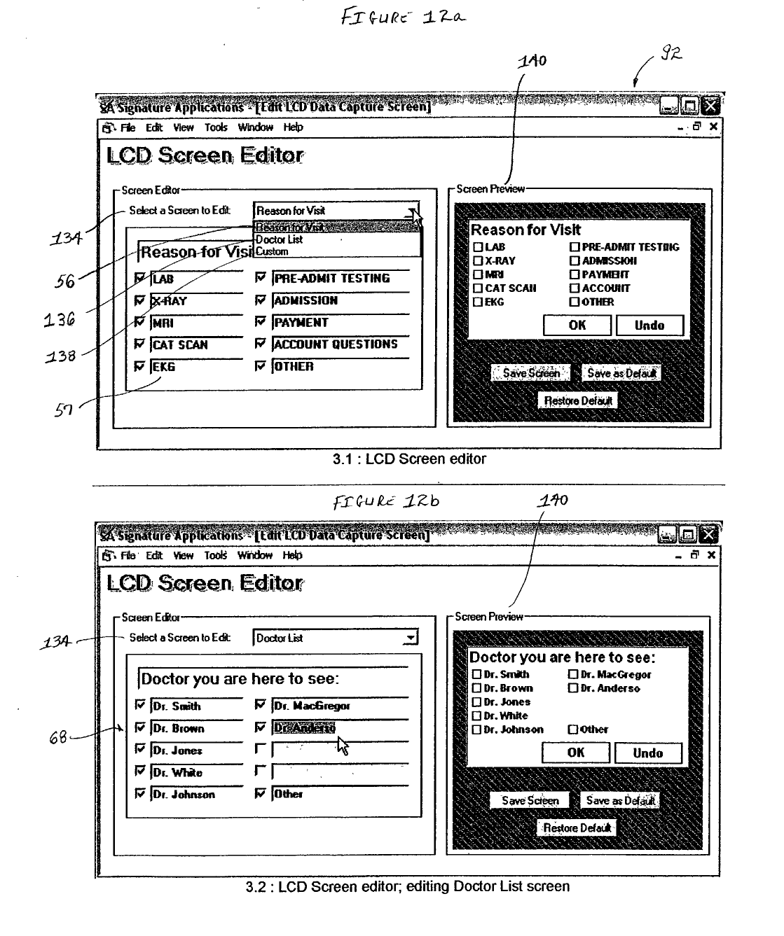

The Client List Folder 126, as illustrated in FIG. 11, displays the same information that is provided in the Sign-Ins Folder 124. This Client List Folder 126 is the primary location where the administrator makes any changes or updates to the profile of an individual 106 who is not currently in the Sign-Ins Folder 124 and requesting access to the restricted or controlled area at that moment. Alternatively, even if the individual 106 is listed in the Sign-Ins Folder 124, the administrator may choose to make any changes or updates in either the Sign-Ins Folder 124 or the Client List Folder 126. The reason is that the information is maintained in one database and is retrieved by both the Sign-Ins Folder 124 and the Client List Folder 126, thereby, allowing each folder to display the same, current information on the individual 106.

Under the edit heading 80, the LCD Screen 92 is illustrated in FIG. 12a. The LCD Screen 92 depicts the screen editor for the administrator to update, change, or alter any screen as desired. Using a Select Screen To Edit Box 134, the administrator can choose from a drop down menu, either the Reason For Visit Screen 56, a Doctor List Screen 136, or any Custom Screen 138 created by the user. If the Reason For Visit Screen 56 is chosen, the reasons 57 are displayed below the Select Screen To Edit Box 134. The administrator may then select any reason 57 for removal from the Reason For Visit Screen 56 (FIG. 7a), delete the reason 57 completely, or change the reason 57 to include a different reason in the Reason For Visit Screen 56. Any changes made by the administrator are displayed in the Screen Preview Box 140.

Alternatively, if the Doctor List Screen 136 is chosen, the doctor list 68 is displayed below the Select Screen To Edit Box 134 as illustrated in FIG. 12b. The administrator may then select any doctor name for removal from the Doctor To See List Screen 66 (FIG. 7b), delete the doctor name completely, or change the doctor name to include a different doctor name in the Doctor To See List Screen 66. Any changes made by the administrator are displayed in the Screen Preview Box 140.

Under the view heading 82, a sign-in form option 94 and a database option 96 are provided. The sign-in form 94 is the same screen as the main screen 104 illustrated in FIG. 9. The database option 96 is the same screen as the Sign-Ins Folder 124 and the Client List Folder 126 provided in the database option 90. Although the screens provided are the same, there exists one difference. Under the edit heading 80, the information in the screens provided may be altered or modified by the administrator in some manner. Under the view heading 82, the information in the screens provided may only be viewed. If the administrator selected to view any screens under the view heading 82 and then, upon review, realized or decided that certain information required alteration or modification, the administrator must go to the appropriate screen under the edit heading 80.

Under the view heading 82, a reports option 98 is provided as illustrated in FIG. 13. The report option 98 depicts an Available Reports Selection 142. The Available Reports Selection 142 consists of four reports: an Average Waiting Room Time Report 144, an Average Clinical Time Report 146, a Client Counts Report 148, and a Reasons For Visit Report 150. If the administrator selects the Average Waiting Room Time Report 144, the report is shown in FIG. 13 adjacent to the Available Report Selection 142. The report is a bar graph of the week, month, or year by the average number of minutes that an individual waited to gain access to the restricted or controlled area after signing in to the system during that period of time.

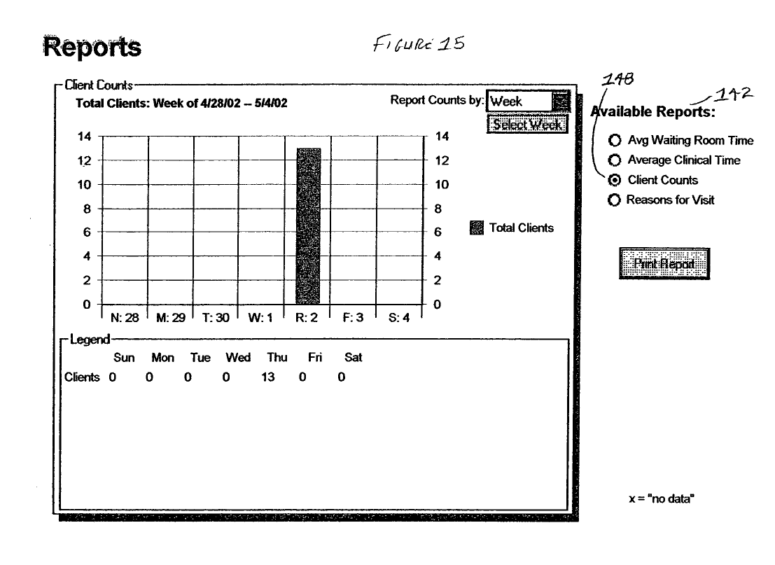

If the administrator selects the Average Clinical Time Report 146, the report is depicted adjacent to the Available Reports Selection 142 as shown in FIG. 14. The report is a bar graph of the week, month, or year by the average number of minutes that an individual had access to the restricted or controlled area after entering the restricted or controlled area of the facility or building. The clinical term is used in FIG. 14 as an example of how long a patient was examined by the doctor. Alternatively, any term may be used provided that it is indicating the average number of minutes that an individual had access to the restricted or controlled area after entering the restricted or controlled area of the facility or building during that period of time.

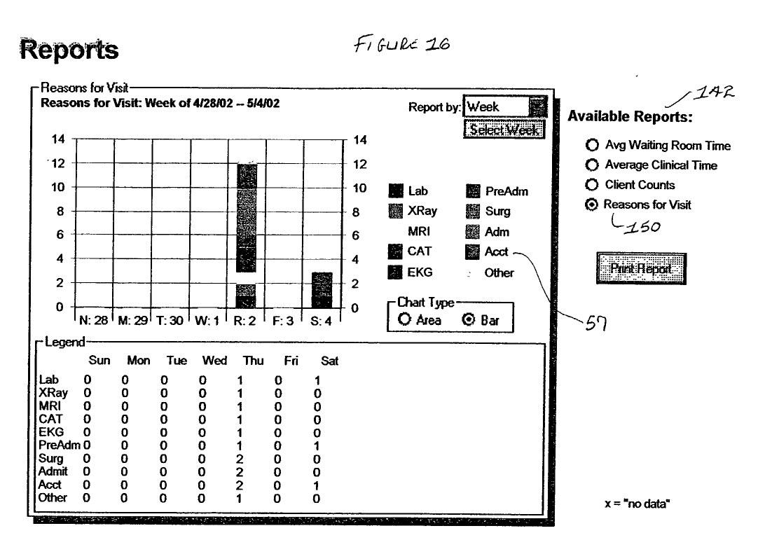

If the administrator selects the Client Counts Report 148, the report is depicted adjacent to the Available Reports Selection 142 as shown in FIG. 15. The report is a bar graph of the week, month, or year by the total number of individuals that waited or gained access to the restricted or controlled area after signing in to the system over that time period.

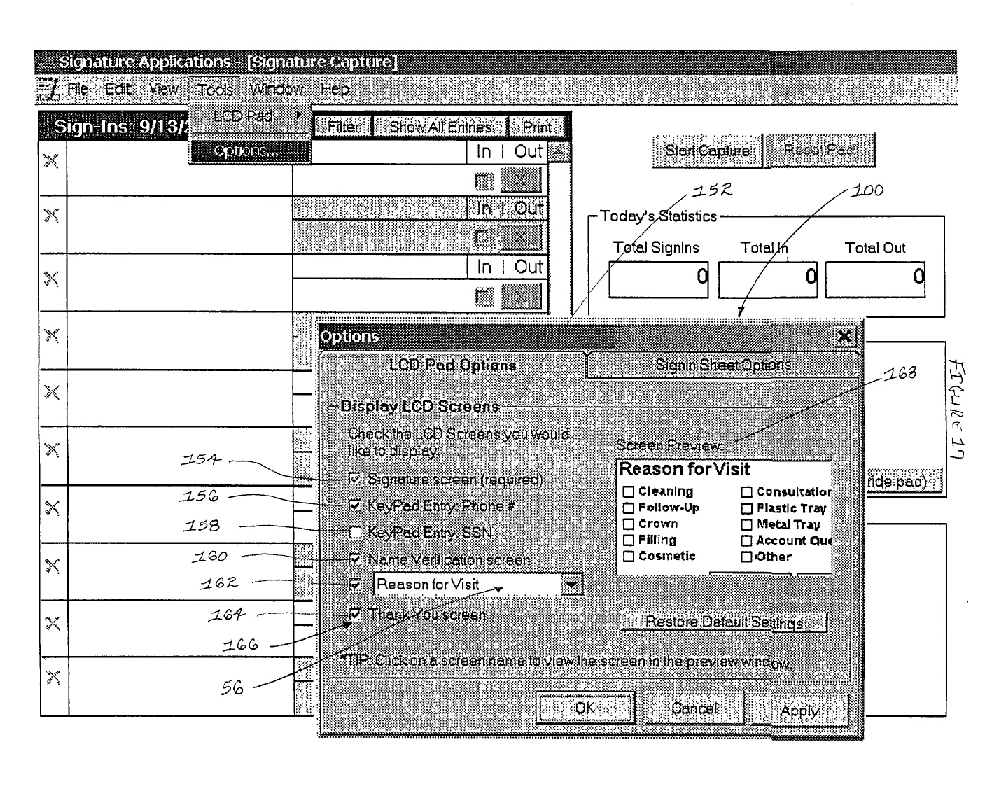

If the administrator selects the Reasons For Visit Report 150, the report is depicted adjacent to the Available Reports Selection 142 as shown in FIG. 16. The report is a bar or area graph of the week, month, or year by the cumulative number of reasons 57 that individuals used in requesting to gain access to the restricted or controlled area during that period of time. Alternatively, this report may be replaced with the cumulative number of which doctors whom individuals requested access to see or visited or any other report customized by the user.

Under the tools heading 84, an LCD pad option 100 is provided as illustrated in FIG. 17. The LCD pad option 100 permits the user to select the variation or combination of steps to enable or disable for use in the process as illustrated in FIG. 2. A Display LCD Screens menu 152 provides a Signature Screen 154, a KeyPad Entry Phone # 156, a KeyPad Entry SSN 158, a Name Verification screen 160, a Customized Screen 162, and a Thank You Screen 164. The Signature Screen 154 corresponds to Steps 101 through 103 and is required at all times. The KeyPad Entry Phone # 156 and KeyPad Entry SSN 158 correspond to Steps 104 through 107. The Name Verification screen 160 corresponds to Steps 108 through 110. The Customized Screen 162 corresponds to Steps 111 through 113. As illustrated, if the Reason For Visit Screen 56 is chosen, the reasons 57 provided under a Screen Preview 168 may be selected for use. The Thank You Screen 164 corresponds to Steps 114 through 115. Next to each screen is a box 166. If the user selects the screen by placing a check mark in the box 166 adjacent to a particular screen, the appropriate steps will be enabled for use. If the user does not place a check mark in the box 166 adjacent to a particular screen, that particular screen will be disabled from use in the process.

Under the tools heading 84, a sign-in sheet option 102 is provided as illustrated in FIG. 18. The sign-in sheet option 102 provides a LCD Screen Timeout Interval 170 which sets the number of seconds that the process will allow the individual to enter their responses into the tableture 16 (FIG. 1). If the individual does not enter their response within that number of seconds the process will reset to the beginning or Step 101 (FIG. 2).

Thus, there has been provided an automated system and method for gaining access to restricted or controlled areas in which the entrant's information is held in a confidential manner from the public. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the appended claims.

What is claimed is:

1. A computer based method for effecting the entry of an individual into a restricted or controlled area, comprising the steps of:
(a) entering a signature on a receiving medium;
(b) receiving the signature into a computer system;
(c) querying the individual to enter a client identification number on the receiving medium;
(d) receiving the client identification number into the computer system;
(e) querying the individual to verify their identity from a list of at least one client name that corresponds to the entered client identification number;
(f) selecting a client name from the list of at least one client name that corresponds to the entered client identification number;
(g) receiving the client name into the computer system;
(h) querying the individual to enter information on the receiving medium relating to accessing the restricted or controlled area;
(i) receiving the information entered into the computer system;
(j) storing the signature, client name, and information into the computer system; and
(k) providing the individual with a greeting displayed in the receiving medium.

2. The method according to claim 1 wherein the client identification number comprises any combination of numbers, letters, or symbols.

3. The method according to claim 1 and further comprising the step of requesting the individual to re-enter the client identification number on the receiving medium if the selected client name was not verified from the list of client names.

4. The method according to claim 1 and further comprising the step of providing the individual with additional instructions if the selected client name was not verified from the list of client names.

5. The method according to claim 1 further comprising the step of storing a date and a time representing when the individual effected entry.

6. The method according to claim 1 further comprising the step of comparing the client identification number with a client table to obtain the list of at least one client name that corresponds to the entered client identification number.

7. The method according to claim 1 further comprising the step of providing a main screen for displaying a list of individuals seeking access to the restricted or controlled area.

8. The method according to claim 1 further comprising the step of providing a database screen for displaying a plurality of information relating to the individual.

9. The method according to claim 8 wherein the plurality of information relating to the individual comprises a sign-in identification number, the client identification number, the client name, a social security number, a telephone number, an address, a city, a state, a zip code, a doctor name, the signature, a date, a time, or a reason for visiting.

10. The method according to claim 1 wherein the information relating to the request to access the restricted or controlled area comprises the subject matter of a reason for visiting list, a doctor list, or any customized subject.

11. The method according to claim 1 further comprising the step of providing a plurality, of reports relating to the individuals seeking access to the restricted or controlled area.

12. The method according to claim 11 wherein the plurality of reports comprises an average waiting room time report, an average clinical time report, a client counts report, and a reason for visit report.

13. A computer based method for effecting the entry of an individual into a restricted or controlled area, comprising the steps of:
(a) entering a signature on an electronic tablet;
(b) receiving the signature into a computer system;
(c) querying the individual to enter a client identification number on the electronic tablet;
(d) receiving the client identification number into the computer system;
(e) querying the individual to verify a client name which matches the individual;
(f) selecting the client name from a list of at least one client name that corresponds to the entered client identification number; and
(g) providing the individual with a greeting displayed in the electronic tablet.

14. The method according to claim 13 and further comprising the step of querying the individual to enter information relating to their request to access the restricted or controlled area on the receiving medium.

15. The method according to claim 14 and further comprising the step of receiving the information entered into the computer system.

16. The method according to claim 1 wherein the information relating to the request to access the restricted or controlled area comprises the subject matter of a reason for visiting list, a doctor list, or any customized subject.

17. The method according to claim 13 and further comprising the step of storing the signature, client name, and information into the computer system.

18. A computer based method for effecting the entry of an individual into a restricted or controlled area, comprising the steps of:
(a) requesting the individual to enter a signature in a receiving medium;
(b) entering the signature on the receiving medium;
(c) receiving the signature in a computer system;
(d) requesting the individual to enter information in the receiving medium relating to accessing the restricted or controlled area;
(e) receiving the information entered into computer system;
(f) providing the individual with a greeting displayed in the receiving medium.

19. The method according to claim 18 and further comprising the step of querying the individual to enter a client identification number on the receiving medium.

20. The method according to claim 19 and further comprising the step of receiving the client identification number into the computer system.

21. The method according to claim 20 and further comprising the step of querying the individual to verify their identity from a list of at least one client name that corresponds to the entered client identification number.

22. The method according to claim 21 and further comprising the step of selecting a client name from the list of at least one client name that corresponds to the entered client identification number.

23. The method according to claim 22 and further comprising the step of receiving the client name into the computer system.

24. The method according to claim 18 and further comprising the step of storing the signature, client name, and information into the computer system.

25. A computer based method for effecting the entry of an individual into a restricted or controlled area, comprising the steps of:
querying the individual to enter a signature in a electronic tablet;
entering the signature on the electronic tablet;
receiving the signature in a computer system;
querying the individual to enter a client identification number in the electronic tablet;
receiving the client identification number entered in the computer system;
if the individual verifies their identity by selecting a client name from a list of at least one client name that corresponds to the entered client identification number, then performing the following steps (a)-(d);
(a) querying the individual to enter information relating to accessing the restricted or controlled area in the electronic tablet;
(b) receiving the information in the computer system;
(c) storing the signature, client name, and information in the computer system;
(d) providing the individual with a greeting displayed in the electronic tablet; and
if the individual's identity cannot be identified by the individual selecting a client name from the list of at least one client name that corresponds to the entered client identification number because their name is not among the at least one client name, then performing the following steps (e)-(j):
(e) querying the individual to re-enter the client identification number in the electronic tablet;
(f) receiving the client identification number in the computer system;
(g) querying the individual to enter information relating to their request to access the restricted or controlled area in the electronic tablet;
(h) receiving the information in the computer system;
(i) storing the signature, client name, and information in the computer system;
(j) providing the individual with a greeting displayed in the electronic tablet.

26. The method according to claim 26 and the further comprising the step of, if the individual is unable to again verify their identity by selecting a client name from the list of at least one client name that corresponds to the entered client identification number because their name is not among the at least one client name, then performing the following step (k):
(k) requesting the individual to see an administrator.

27. A computer program product comprising a computer storage medium having a computer program code mechanism embedded in the computer storage medium for use with a receiving medium for allowing an individual to gain access to a restricted or controlled area, the computer program code mechanism comprising:
a first computer code device configured to query the individual to enter a signature in a receiving medium;
a second computer code device configured to receive the signature entered into the receiving medium;
a third computer code device configured to query the individual to enter a client identification number in the receiving medium;
a fourth computer code device configured to receive the client identification number entered into the receiving medium;
a fifth computer code device configured to query the individual to verify their identity a client name from a list of at least one client name that corresponds to the entered client identification number;
a sixth computer code configured to receive the client name,
a seventh computer code device configured to query the individual to enter information relating to accessing the restricted or controlled area in the receiving medium;
a eighth computer code device configured to receive the information entered into the receiving medium;
a ninth computer code device configured to store the signature, client name, and information into the computer system; and
a tenth computer code device configured to provide the individual with a greeting displayed in the receiving medium.

28. A system for effecting the entry of an individual into a restricted or controlled area, comprising:
means for requesting the individual to enter a signature in an electronic tablet;
means for receiving the signature entered into a computer system;
means for requesting the individual to enter a client identification number in the electronic tablet;
means for receiving the client identification number into the computer system;
means for requesting the individual to verify their identity by selecting a client name from a list of at least one client name that corresponds to the entered client identification number,
means for requesting the individual to enter information relating to accessing the restricted or controlled area in the electronic tablet;
means for receiving the information into the computer system;
means for storing the signature, client name, and information into the computer system; and
means for providing the individual with a greeting displayed in the electronic tablet.
